(19) United States
(12) Patent Application Publication
(10) Pub. No.: US 2012/0210978 A1
(43) Pub. Date: Aug. 23, 2012

(54) FUEL SYSTEM ABNORMALITY DETECTION APPARATUS

(75) Inventors: Toshikazu Kato, Toyota-shi (JP); Hideyuki Tsuzuki, Toyota-shi (JP)

(73) Assignee: TOYOTA JIDOSHA KABUSHIKI KAISHA, Toyota-shi (JP)

(21) Appl. No.: 13/401,338

(22) Filed: Feb. 21, 2012

(30) Foreign Application Priority Data
Feb. 22, 2011 (JP) 2011-035861

(51) Int. Cl. F02P 5/04

(52) U.S. Cl. 123/406.19

(57) ABSTRACT

An electronic control apparatus that performs feedback control on a fuel injection command value to make an air-fuel ratio come to match a target air-fuel ratio increase-corrects an intake air amount and retard-corrects an ignition timing, together with decrease-correcting the fuel injection command value in the feedback control, and then performs an abnormality detection of a fuel system based on a retard-correction amount of the ignition timing at that time.

### INCORPORATION BY REFERENCE

The disclosure of Japanese Patent Application No. 2011-035861 filed on Feb. 22, 2011 including the specification, drawings and abstract is incorporated herein by reference in its entirety.

### BACKGROUND OF THE INVENTION

1. Field of the Invention

The invention relates to an apparatus that detects an abnormality of a fuel system of an internal combustion engine that performs feedback control on a fuel injection command value to make an air-fuel ratio match a target air-fuel ratio.

2. Description of Related Art

In an internal combustion engine mounted in a vehicle, the air-fuel ratio of a combusted air-fuel mixture is detected from the oxygen concentration of the exhaust gas, and feedback control on a fuel injection command value (i.e., injection time) is performed such that the detected air-fuel ratio comes to match a target air-fuel ratio. In an internal combustion engine, the quantity of the injected fuel is controlled by the implementation time of the fuel injection of an injector in one injection. The quantity of the injected fuel is increased by lengthening the fuel injection time per injection, and decreased by reducing the fuel injection time per injection.

On the other hand, in an internal combustion engine, as a member of the fuel system, such as the injector, deteriorates with use over an extended period time, the injection rate of the injector, i.e., the quantity of the injected fuel per unit time, consequently changes. As the injection rate of the injector changes, the fuel injection command value necessary for injecting a desired quantity of fuel also changes. As a result, a correction amount of the fuel injection command value in the air-fuel ratio feedback control also changes.

For example, when the injection rate of the injector increases due to changing over time or a failure or the like, the quantity of fuel injected per unit time increases, so the fuel injection command value necessary to obtain the target air-fuel ratio becomes smaller. Also, when the injection rate of the injector decreases, the quantity of fuel injected per unit time decreases, so the fuel injection command value necessary to obtain the target air-fuel ratio becomes larger.

Therefore, if the correction amount of the fuel injection command value in the air-fuel ratio feedback control is a value outside of a suitable range, the injection rate of the injector will be outside of the normal range, so it can be determined that there is an abnormality in the fuel system. Therefore, an apparatus that detects an abnormality of a fuel system based on the correction amount of the fuel injection command value in air-fuel ratio feedback control has been proposed and put into practical use, as can be seen with Japanese Patent Application Publication No. 03-23336 (JP-A-03-23336), for example.

When the injection rate of the injector increases due to changing over time or the like, the fuel injection command value is decrease-corrected by the air-fuel ratio feedback control. However, under operating conditions in which the intake air amount is small, such a decrease-correction may result in the fuel injection command value falling below a minimum allowable value that is dictated by hardware limitations of the injector. In this case, the fuel injection command value is unable to be decrease-corrected any further. Therefore, an abnormality of the fuel system is unable to be accurately detected even based on the correction amount of the fuel injection command value at this time.

Also, if an increase-correction of the intake air amount and a retard-correction of the ignition timing were performed, the fuel injection command value may end up falling below the minimum allowable value. In this case, a decrease-correction of the fuel injection command value is unable to be performed to the extent necessary, so an accurate abnormality detection of the fuel system is unable to be performed even based on the correction amount of the fuel injection command value at this time.

### SUMMARY OF THE INVENTION

This invention provides a fuel system abnormality detection apparatus capable of accurately detecting an abnormality of a fuel system even when a fuel injection command value is unable to be sufficiently decrease-corrected by air-fuel ratio feedback control.

A first aspect of the invention relates to an apparatus for detecting an abnormality of a fuel system of an internal combustion engine, that includes an electronic control unit that performs feedback control on a fuel injection command value to make an air-fuel ratio come to match a target air-fuel ratio, in which the electronic control unit performs an abnormality detection of the fuel system based on a retard-correction amount of an ignition timing when increase-correcting an intake air amount and retard-correcting the ignition timing, together with decrease-correcting the fuel injection command value in the feedback control.

Also, the electronic control unit may maintain the air-fuel ratio at the target air-fuel ratio by increase-correcting an intake air amount and retard-correcting an ignition timing, when a fuel injection quantity after a decrease-correction by the feedback control is a minimum allowable value, and perform an abnormality detection of the fuel system based on a retard-correction amount of the ignition timing at that time.

In this way, it is possible to accurately detect an abnormality of the fuel system, even when the fuel injection command value is unable to be sufficiently decrease-corrected by air-fuel ratio feedback control, based on the retard-correction amount of the ignition timing when increase-correcting the intake air amount and retard-correcting the ignition timing to achieve a target air-fuel ratio. The electronic control unit may also perform the abnormality detection of the fuel system based on the increase-correction amount of the intake air amount, in addition to the retard-correction amount of the ignition timing.

The electronic control unit may also perform an abnormality detection of the fuel system based on an increase-correction amount of an intake air amount when increase-correcting the intake air amount and retard-correcting an ignition timing, together with decrease-correcting the fuel injection command value in the feedback control.

Also, the electronic control unit may maintain the air-fuel ratio at the target air-fuel ratio by increase-correcting an intake air amount and retard-correcting an ignition timing, when a fuel injection quantity after a decrease-correction by the feedback control is a minimum allowable value, and perform an abnormality detection of the fuel system based on an increase-correction amount of the intake air amount at that time.

In this way, it is possible to accurately detect an abnormality of a fuel system, even when a fuel injection command value is unable to be sufficiently decrease-corrected by air-fuel ratio feedback control, based on an increase-correction amount of an intake air amount when increase-correcting the intake air amount and retard-correcting the ignition timing to obtain a target air-fuel ratio.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing a frame format of the structure of an internal combustion engine to which an example embodiment of the invention may be applied; and

FIG. 2 is a flowchart of a fuel system abnormality detection routine used in the example embodiment.

### DETAILED DESCRIPTION OF EMBODIMENTS

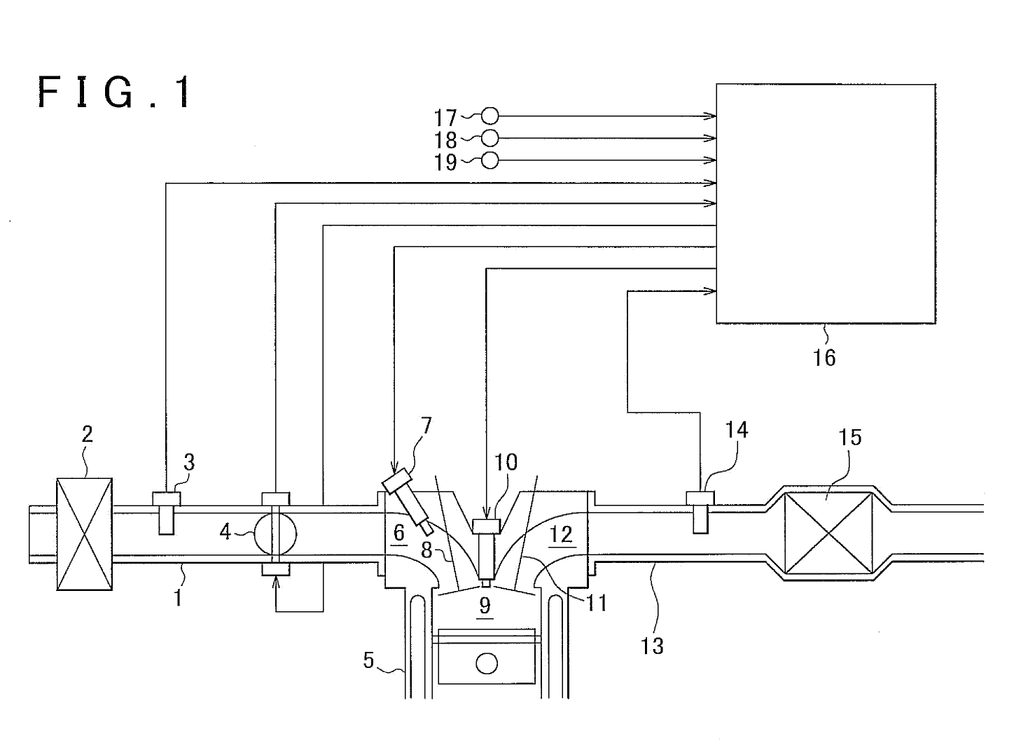

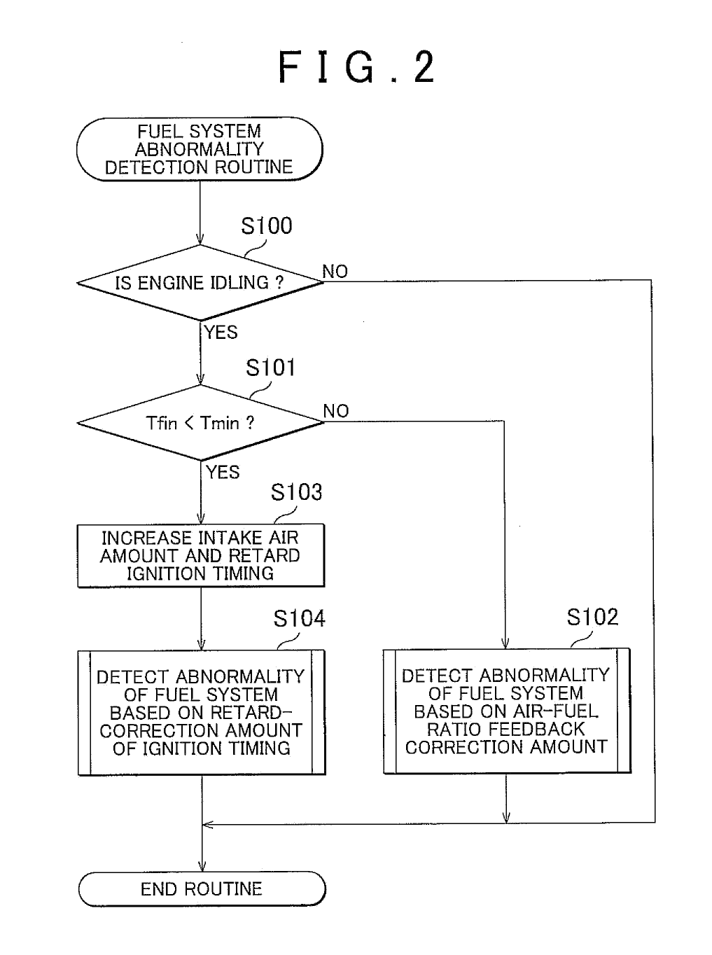

Hereinafter, an example embodiment of the abnormality detection apparatus of the invention will be described in detail with reference to FIGS. 1 and 2. First, the structure of an internal combustion engine to which the example embodiment of the invention may be applied will be described with reference to FIG. 1. As shown in FIG. 1, an air-cleaner 2 that cleans intake air, an airflow meter 3 that detects an intake air amount, and a throttle valve 4 that regulates the intake air amount, are provided in order from upstream, in an intake pipe 1 of the internal combustion engine. The intake pipe 1 is connected, downstream of the throttle valve 4, to an intake port 6 formed in a cylinder block 5 of the internal combustion engine.

An injector 7 that injects fuel into the intake air is provided in the intake port 6. Also, the intake port 6 is connected to a combustion chamber 9 via an intake valve 8. A spark plug 10 that ignites the air-fuel mixture introduced into the combustion chamber 9 is provided in the combustion chamber 9. Also, the combustion chamber 9 is also connected to an exhaust port 12 via an exhaust valve 11.

An exhaust pipe 13 is connected downstream of the exhaust port 12. An air-fuel ratio sensor 14 that detects an oxygen concentration in the exhaust gas, and a catalyst 15 that purifies toxic substances in the exhaust gas, are arranged in the exhaust pipe 13.

This kind of internal combustion engine is controlled by an electronic control unit (ECU) 16. The ECU 16 includes a Central Processing Unit (CPU) that executes various calculations for engine control, and Read-Only Memory (ROM) in which engine control programs and data are stored. The ECU 16 also includes Random Access Memory (RAM) that temporarily stores the calculation results of the CPU and the detection results of sensors and the like, and Input/Output (I/O) ports that serve as an interface for sending and receiving signals to and from external devices.

Various sensors are connected to the input port of the ECU 16. Some examples of these sensors include the airflow meter 3 and the air-fuel ratio sensor 14 described above, as well as a throttle sensor 17 that detects a throttle opening amount, an accelerator pedal sensor 18 that detects an operation amount of an accelerator pedal, and an NE sensor 19 that detects an engine speed. Also, drive circuits of actuators; such as the throttle valve 4, the injector 7, and the spark plug 10, are connected to the output port of the ECU 16.

In the internal combustion engine structured as described above, the ECU 16 executes air-fuel ratio control as part of engine control. When executing air-fuel ratio control, the ECU 16 calculates the fuel quantity necessary to obtain a target air-fuel ratio, by dividing the intake air amount (quantity) detected by the airflow meter 3, by the target air-fuel ratio. The ECU 16 then calculates the amount of time that it takes for the injector 7 to inject the calculated quantity of fuel (this amount of time will be referred to as the “injection time”) as a base injection command value. Here, if the injection characteristic of the injector 7 is as designed, the target air-fuel ratio is able to be obtained by performing a fuel injection according to the base injection command value. However, there may be variation due to individual differences and changes over time in the injection characteristic of the injector 7. Therefore, the target air-fuel ratio is obtained by correcting this base injection command value with an air-fuel ratio feedback correction value calculated according to the difference between the actual air-fuel ratio detected by the air-fuel ratio sensor 14 and the target air-fuel ratio.

The absolute value of the air-fuel ratio feedback correction value at this time increases according to an increase in the offset between the actual value and the design value of the injection characteristic of the injector 7. Therefore, the ECU 16 detects an abnormality of the fuel system based on the air-fuel ratio feedback correction value when the internal combustion engine is idling, at which time the operating conditions are stable. That is, the ECU 16 detects an abnormality of the fuel system by determining that there is an abnormality if the air-fuel ratio feedback correction value when idling is outside of the normal range.

When the injection rate (i.e., the fuel injection quantity per unit time) of the injector 7 increases, the fuel injection command value decreases by air-fuel ratio control. However, there is a minimum injection time for the injector 7 that is dictated by hardware limitations, and as a result, the fuel injection command value is unable to be decreased beyond a certain value. Therefore, if the fuel injection quantity necessary to obtain the target air-fuel ratio is less than a minimum allowable value dictated by the hardware limitations of the injector 7, the quantity of fuel that is actually injected will be maintained at the minimum allowable value, even though there is a difference between the actual air-fuel ratio and the target air-fuel ratio, so the offset of the injection characteristic of the injector 7 will not be reflected in the air-fuel ratio feedback correction value. As a result, an abnormality of the fuel system will be unable to be accurately detected even based on the air-fuel ratio feedback correction value at this time.

Therefore, in this example, embodiment, the ECU 16 performs the control described below so as to be able to accurately detect an abnormality of the fuel system even in such a case. That is, in this example embodiment, the intake air amount is increased when the fuel injection quantity necessary to obtain the target air-fuel ratio is the minimum allowable value. The increase of the intake air amount is performed such that an intake air amount at which the actual air-fuel ratio is able to match the target air-fuel ratio while the fuel injection quantity is equal to or greater than the minimum allowable value is able to be obtained. The intake air amount is increased at this time by increasing the throttle opening amount.

However, if the intake air amount is increased in this way, and the quantity of fuel that is injected is increased in conjunction with this increase, the output of the internal combustion engine will increase and the idle speed will end up increasing. Therefore, in this example embodiment, a retard-correction of the ignition timing is performed together with the increase in the intake air amount. As a result, combustion will be slower so less torque will be generated, thereby enabling an increase in the output of the internal combustion engine to be avoided.

In this case, the intake air amount is increased more and the ignition timing is retarded more as the fuel injection quantity necessary to obtain the target air-fuel ratio decreases below the minimum allowable value. That is, as the injection characteristic of the injector 7 becomes farther off to the side where the injection rate is increased, the increase-correction amount of the intake air amount and the retard-correction amount of the ignition timing at this time increase. Therefore, an abnormality of the fuel system can be detected when the increase-correction amount of the intake air amount and the retard-correction amount of the ignition timing at this time become excessive. Therefore, in this example embodiment, when the fuel injection command value necessary to obtain the target air-fuel ratio becomes less than the minimum allowable value, an abnormality detection of the fuel system is performed based on the retard-correction amount of the ignition timing.

FIG. 2 is a flowchart of a fuel system abnormality detection routine used in this example embodiment. This routine is repeatedly executed in cycles by the ECU 16 while the engine is operating.

When the routine starts, first in step S100, it is determined whether the engine is idling. If it the engine is not idling (i.e., NO in step S100), this cycle of the routine directly ends.

If, on the other hand, the engine is idling (i.e., YES in step S100), then in step S101, it is determined whether a fuel injection command value Tfin after a correction by an air-fuel ratio feedback correction value is less than a minimum allowable value Tmin. If the fuel injection command value Tfin after a correction is equal to or greater than the minimum allowable value Tmin (i.e., NO in step S101), then in step S102, an abnormality detection of the fuel system is performed based on an air-fuel ratio feedback correction value FAF at this time. In the abnormality detection at this time, it is determined that there is an abnormality of the fuel system when the air-fuel ratio feedback correction value FAF is outside of a specified normal range.

If, on the other hand, the fuel injection command value Tfin after a correction is less than the minimum allowable value Tmin (i.e., YES in step S101), then in step S103, the intake air amount is increase-corrected to obtain the target air-fuel ratio while the fuel injection command value Tfin is equal to or greater than the minimum allowable value Tmin, and the ignition timing is retard-corrected to cancel out the increase in engine torque that accompanies the increase in the intake air amount. Next in step S104, an abnormality detection of the fuel system is performed based on the retard-correction amount of the ignition timing. In the abnormality detection at this time, it is determined that there is an abnormality in the fuel system when the retard-correction amount of the ignition timing is equal to or greater than a specified abnormality determining value.

The fuel system abnormality detection apparatus according to the example embodiment described above is able to yield the effects described below. (1) In this example embodiment, the ECU 16 performs an abnormality detection of the fuel system based on the retard-correction amount of the ignition timing when decrease-correcting the fuel injection command value, and increase-correcting the intake air amount and retard-correcting the ignition timing. More specifically, when the fuel injection command value Tfin after a decrease-correction is less than the minimum allowable value Tmin, the actual fuel injection quantity after the decrease-correction becomes the minimum allowable value. In response, the ECU 16 maintains the air-fuel ratio at the target air-fuel ratio by increase-correcting the intake air amount and retard-correcting the ignition timing, when the fuel injection quantity after the decrease-correction by feedback control is the minimum allowable value. Then the ECU 16 performs an abnormality detection of the fuel system based on the retard-correction amount of the ignition timing at this time. Therefore, an abnormality of the fuel system is able to be accurately detected, even in a situation in which normally the fuel injection command value is unable to be sufficiently decrease-corrected by air-fuel ratio feedback control.

The example embodiment described above may also be implemented with the modifications described below.

In the example embodiment described above, the intake air amount is increase-corrected and the ignition timing is retard-corrected while the fuel injection command value is decrease-corrected, and an abnormality detection of the fuel system is performed based on the retard-correction amount of the ignition timing when the air-fuel ratio matches the target air-fuel ratio. The increase-correction amount of the intake air amount, or the increase-correction amount of the throttle opening amount, at this time also increases as the injection characteristic of the injector 7 becomes farther off to the side where the injection rate increases. Therefore, an abnormality detection of the fuel system is also able to be performed based on the increase-correction amount of the intake air amount (i.e., the increase-correction amount of the throttle opening amount) at this time. The abnormality detection of the fuel system may also be performed based on both the retard-correction amount of the ignition timing and the increase-correction amount of the intake air amount (i.e., the increase-correction amount of the throttle opening amount) at this time.

In this example embodiment, the target air-fuel ratio is maintained by directly controlling (i.e., manipulating) the intake air amount (i.e., the throttle opening amount) and the ignition timing when the fuel injection command value is unable to be decreased any further. Of course, if idle speed control is in the middle of being executed, it is possible to both retard the ignition timing and increase the intake air amount by only directly controlling the ignition timing. That is, in idle speed control, the intake air amount is feedback-controlled such that the engine speed comes to match a target idle speed. Here, when the ignition timing is retarded, the engine output drops and the engine speed falls. Therefore, the intake air amount at this time is increased by idle speed control in order to raise the engine speed that had fallen. Therefore, in idle speed control, the intake air amount is able to be increased and the ignition timing is able to be retarded simply by directly controlling only the ignition timing.

In the example embodiment described above, the intake air amount is increased and the ignition timing is retarded when the fuel injection command value after an air-fuel ratio feedback correction becomes less than the minimum allowable value. Alternatively, however, the intake air amount may be increased and the ignition timing may be retarded when the decrease amount of the fuel injection command value according to air-fuel ratio feedback becomes equal to or greater than a certain value.

The example embodiment of the invention may be summarized as follows. According to the example embodiment, even in a situation in which the fuel injection command value is unable to be sufficiently decrease-corrected by air-fuel ratio feedback control, the target air-fuel ratio can be obtained without increasing engine output, by increase-correcting the intake air amount in combination with retard-correcting the ignition timing. That is, the fuel quantity necessary to obtain the target air-fuel ratio can be increased by increase-correcting the intake air amount when the fuel injection command value falls below the minimum allowable value. Increasing the necessary fuel quantity in this way makes it possible to bring the fuel injection command value after a decrease-correction to within a range where it is able to be set, and thus enables the air-fuel ratio to be maintained at the target air-fuel ratio.

However, when the quantity of fuel that is injected is increased with the intake air quantity in this way, the output of the internal combustion engine ends up increasing. Therefore, in addition to increasing the intake air amount, the ignition timing is retard-corrected, which slows combustion so less torque will be generated, thereby enabling an increase in the output of the internal combustion engine to be avoided.

Here, if the injection rate of the injector increases due to changing over time or a failure or the like, and as a result, the decrease-correction amount of the fuel injection command value by air-fuel ratio feedback control increases, the increase-correction amount of the intake air amount and the retard-correction amount of the ignition timing at this time are increased. As a result, an abnormality of the fuel system can be detected when the increase-correction amount of the intake air amount and the retard-correction amount of the ignition timing at this time become excessive.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. An apparatus for detecting an abnormality of a fuel system of an internal combustion engine, comprising:
an electronic control unit that performs feedback control on a fuel injection command value to make an air-fuel ratio come to match a target air-fuel ratio,
wherein the electronic control unit performs an abnormality detection of the fuel system based on a retard-correction amount of an ignition timing when increase-correcting an intake air amount and retard-correcting the ignition timing, together with decrease-correcting the fuel injection command value in the feedback control.

2. An apparatus for detecting an abnormality of a fuel system of an internal combustion engine, comprising:
an electronic control unit that performs feedback control on a fuel injection command value to make an air-fuel ratio come to match a target air-fuel ratio,
wherein the electronic control unit maintains the air-fuel ratio at the target air-fuel ratio by increase-correcting an intake air amount and retard-correcting an ignition timing, when a fuel injection quantity after a decrease-correction by the feedback control is a minimum allowable value, and performs an abnormality detection of the fuel system based on a retard-correction amount of the ignition timing at that time.

3. The apparatus according to claim 1, wherein the electronic control unit performs the abnormality detection of the fuel system based on the increase-correction amount of the intake air amount, in addition to the retard-correction amount of the ignition timing.

4. An apparatus for detecting an abnormality of a fuel system of an internal combustion engine, comprising:
an electronic control unit that performs feedback control on a fuel injection command value to make an air-fuel ratio come to match a target air-fuel ratio,
wherein the electronic control unit performs an abnormality detection of the fuel system based on an increase-correction amount of an intake air amount when increase-correcting the intake air amount and retard-correcting an ignition timing, together with decrease-correcting the fuel injection command value in the feedback control.

5. An apparatus for detecting an abnormality of a fuel system of an internal combustion engine, comprising:
an electronic control unit that performs feedback control on a fuel injection command value to make an air-fuel ratio come to match a target air-fuel ratio,
wherein the electronic control unit maintains the air-fuel ratio at the target air-fuel ratio by increase-correcting an intake air amount and retard-correcting an ignition timing, when a fuel injection quantity after a decrease-correction by the feedback control is a minimum allowable value, and performs an abnormality detection of the fuel system based on an increase-correction amount of the intake air amount at that time.

6. The apparatus according to claim 1, wherein the internal combustion engine is mounted in a vehicle, and the feedback control is executed while the vehicle is idling.

7. The apparatus according to claim 1, wherein the electronic control unit performs the abnormality detection of the fuel system based on a correction value by the feedback control, when a fuel injection quantity after a decrease-correction by the feedback control is equal to or greater than a minimum allowable value.

8. A method for detecting an abnormality of a fuel system of an internal combustion engine that performs feedback control on a fuel injection command value to make an air-fuel ratio come to match a target air-fuel ratio, comprising:
determining whether a fuel injection quantity after a decrease-correction by the feedback control is a minimum allowable value;
increase-correcting an intake air amount and retard-correcting an ignition timing such that the air-fuel ratio comes to match the target aft-fuel ratio, when the fuel injection quantity after a decrease-correction by the feedback control is the minimum allowable value; and
detecting an abnormality of the fuel system based on a retard-correction amount of the ignition timing.
